(19) United States
(12) Patent Application Publication
(10) Pub. No.: US 2015/0021259 A1
(43) Pub. Date: Jan. 22, 2015

(54) FLUSH VALVE FILTER

(71) Applicant: H2OK Solutions LLC, Apple Valley, MN (US)

(72) Inventor: Jeff Dirkers, Burnsville, MN (US)

(73) Assignee: H2OK Solutions LLC, Apple Valley, MN (US)

(21) Appl. No.: 14/331,317

(22) Filed: Jul. 15, 2014

Related U.S. Application Data
(60) Provisional application No. 61/847,169, filed on Jul. 17, 2013.

(51) Int. Cl. B01D 35/02; B01D 29/58; B01D 29/13

(52) U.S. Cl. CPC B01D 35/02; B01D 29/13; B01D 29/58
USPC 210/335; 210/499

(57) ABSTRACT

One embodiment includes a flush valve filter assembly. The flush valve filter includes a support structure configured to be placed in a conduit between a flush valve and a fluid inlet line. The support structure includes at least one locking finger extending in a first axial direction and at least two axially extending upper aprons extending in the first axial direction with a locking lip on each upper apron. The at least one locking finger is located between the at least two upper aprons. The flush valve filter assembly also includes a primary filter medium having sieve openings secured to the support structure by the at least one locking finger and locking lip such that at least some particulate in a fluid passing through the flush valve filter is retained by the primary filter medium.

### BACKGROUND

The present embodiments relate generally to filters and, more particularly, to flush valve filters.

Flush valves in water closets or urinals commonly are either piston-type or diaphragm-type. In a piston-type flush valve, a bypass orifice passes through the piston assembly providing inlet fluid pressure above the piston for closing as well as subsequently holding the piston assembly on the valve seat after the flush operation. The bypass orifice is designed such that the bypass orifice is sized to allow a predetermined amount of flow through the flush valve prior to the valve closing during a flush operation. In a diaphragm-type flush valve, a flexible diaphragm is used to separate the flush valve inlet and outlet. Typically, a diaphragm-type flush valve has a pressure chamber situated above the diaphragm to keep the diaphragm positioned on the diaphragm's seat to allow for valve closure. The diaphragm contains a bypass orifice connecting the flush valve inlet to the pressure chamber which allows water therethrough to move the diaphragm to the diaphragm's valve closing position. For both piston-type and diaphragm-type flush valves, proper and efficient functioning of the bypass orifice is critical to flush valve operation.

Flush valve water supply often contains particulate, such as sediment and metallic particles, which can cause partial or total clogging of the bypass orifice. Even partial clogging of the bypass orifice disrupts flush operation, as less than the needed volume of water is supplied and consequently the flush valve is prevented from functioning as designed. Thus, ensuring large particulate in the water supply does not reach the bypass orifice is essential to the operation of the flush valve.

Prior flush valve filters were located either at or near the bypass orifice where clearance is small, requiring these prior flush valve filters to be sized to fit the small clearance. Given the small size of these prior flush valve filters, they are prone to filling quickly with water supply particulate, and therefore, inhibiting water flow through the filter to the bypass orifice, and ultimately proper functioning of the flush valve.

### SUMMARY

One embodiment includes a flush valve filter assembly. The flush valve filter includes a support structure configured to be placed in a conduit between a flush valve and a fluid inlet line. The support structure includes at least one locking finger extending in a first axial direction and at least two axially extending upper aprons extending in the first axial direction with a locking lip on each upper apron. The at least one locking finger is located between the at least two upper aprons. The flush valve filter assembly also includes a primary filter medium having sieve openings secured to the support structure by the at least one locking finger and locking lip such that at least some particulate in a fluid passing through the flush valve filter is retained by the primary filter medium.

Another embodiment includes a flush valve filter assembly that includes a support structure configured to be placed in a conduit between a flush valve and a fluid inlet line having a circumferentially continuous axially extending upper apron with a locking lip located on at least a portion of the upper apron. Also included is a screen basket secured to the support structure by the locking lip.

A further embodiment includes a flush valve filter. The flush valve filter includes a support structure configured to be placed in a conduit between a flush valve and a fluid inlet line. The support structure includes at least two axially extending lower aprons of a first length. The flush valve filter also includes a screen basket secured to the support structure such that at least some particulate in a fluid passing through the flush valve filter is retained by the screen basket. The screen basket is of a second length that is greater than the first length.

### BRIEF DESCRIPTION OF THE DRAWINGS

FIG. 1 shows an axial section view of a flush valve with a flush valve filter.

FIG. 2 shows a perspective view of an embodiment of the flush valve filter of FIG. 1.

FIG. 3 shows a side elevational view of the flush valve filter of FIG. 2.

FIG. 4 shows a cross-sectional view of the flush valve filter of FIG. 2.

FIG. 5 shows a top plan view of the flush valve filter of FIG. 2.

FIG. 6 shows a bottom plan view of the flush valve filter of FIG. 2.

FIG. 7 shows a perspective view of the support structure of the flush valve filter of FIG. 2.

FIG. 8 shows a perspective view of the initial screen of the flush valve filter of FIG. 2.

FIG. 9 shows a perspective view of the screen basket of the flush valve filter of FIG. 2.

FIG. 10 shows a perspective view of another embodiment of an initial screen.

FIG. 11 shows a cross-sectional view of another embodiment of a screen basket.

FIG. 12 shows a perspective view of another embodiment of a flush valve filter.

While the above-identified drawing figures set forth multiple embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals indicate like structures throughout the drawing figures.

### DETAILED DESCRIPTION

Generally, the present embodiments provide a flush valve filter configured to be placed in a conduit between a flush valve and a fluid inlet line. By positioning the flush valve filter in this location, the flush valve filter can be sized larger than prior flush valve filters resulting in the need for less maintenance. Yet, the bypass orifice is still protected from clogging, ensuring proper flush valve operation. Although an embodiment of the flush valve filter is shown in conjunction with a diaphragm-type flush valve, a person of ordinary skill in the art will readily recognize the flush valve filter can also be used similarly in conjunction with a piston-type flush valve or any other type of flush valve.

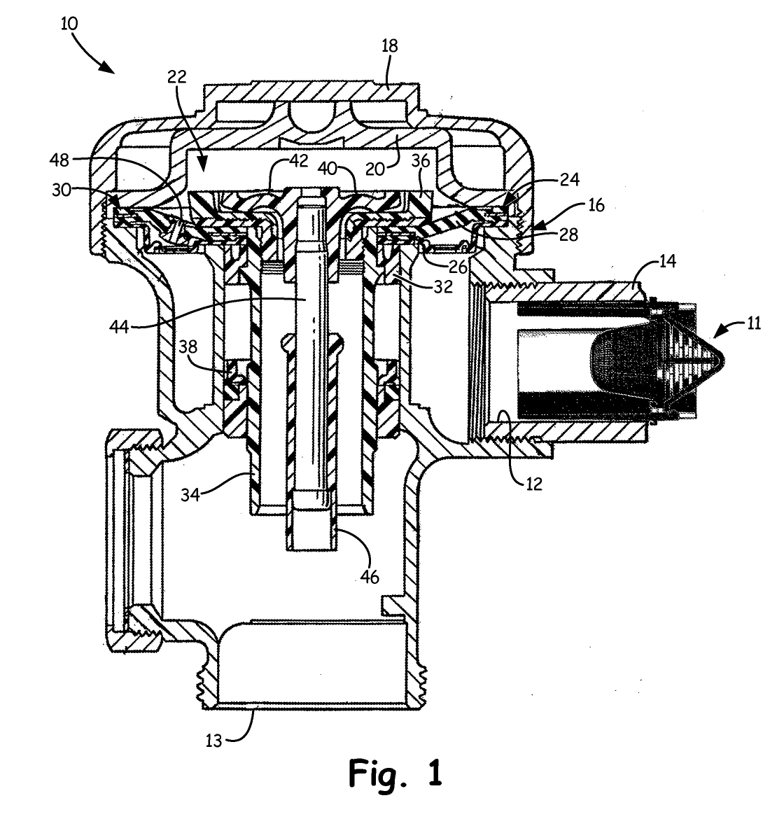

FIG. 1 shows an axial section view of flush valve 10 with one embodiment of flush valve filter 11 installed. Flush valve 10 is a typical diaphragm-type flush valve used in toilet rooms, available as Regal™ from Sloan Valve Company, Franklin Park, Ill. Flush valve 10 includes fluid inlet line 12 and outlet 13 connected to either a toilet or urinal (not shown). A conduit 14 is attached at fluid inlet line 12, and typically is coupled to a valve (not shown) for controlling a supply of water. Placed in conduit 14 between flush valve 10 and fluid inlet line 12 is flush valve filter 11. Locating flush valve filter 11 here allows for easy access for maintenance and repair, as compared to prior art filters located within the tight clearances of flush valve 10 which requires significant disassembly of flush valve 10 to access flush valve filter 11.

Flush valve 10 also includes threaded connection 16, valve cover 18, inner cover 20, pressure chamber 22, diaphragm assembly 24, valve seat 26, diaphragm 28 and outer periphery 30 of diaphragm 28, refill head 32, tubular guide 34, ring 36, flow ring 38, auxiliary valve assembly 40, relief valve head 42, relief valve stem 44, sleeve 46, and bypass orifice 48.

Threaded connection 16 attaches valve cover 18 and inner cover 20, with valve cover 18 overlying inner cover 20. Inner cover 20 creates the top side of pressure chamber 22. Pressure chamber 22 sits atop diaphragm assembly 24. Diaphragm assembly 24 is kept in a closed position on valve seat 26 by pressure chamber 22. Diaphragm assembly 24 includes diaphragm 28, typically made of a flexible material. Outer periphery 30 is secured in the location shown by inner cover 20. Also included in diaphragm assembly 24 is refill head 32, tubular guide 34 threaded to ring 36, and flow ring 38, which are described and shown in U.S. Pat. No. 5,295,655 assigned to Sloan Valve Company.

Tubular guide 34 includes auxiliary valve assembly 40. Auxiliary valve assembly 40 has relief valve head 42 coupled to relief valve stem 44. Relief valve stem 44 has sleeve 46 which is slidable on relief valve stem 44. Relief valve head 42, relief valve stem 44, and sleeve 46 are detailed in U.S. Pat. No. 5,755,253 assigned to Sloan Valve Company.

Diaphragm assembly 24 has bypass orifice 48 which receives water that has passed through flush valve filter 11. For proper flush valve 10 operation, water flow must be directed along a path from conduit 14 and into pressure chamber 22 so that diaphragm assembly 24 is able to close upon valve seat 26. Typically, once diaphragm assembly 24 is closed upon valve seat 26 and pressure chamber 22 is filled with water to keep diaphragm assembly 24 in a closed position, flush valve 10 works by tipping of the auxiliary valve assembly 40. This tipping moves relief valve head 42 off of the position shown within ring 36 allowing water from pressure chamber 22 to flow towards outlet 13. Water entering through fluid inlet line 12 causes diaphragm assembly 24 to raise up from a closed position on valve seat 26, resulting in water flowing directly from fluid inlet line 12 to outlet 13. When this happens, pressure chamber 22 is refilled by water passing through bypass orifice 48. Therefore, for flush valve 10 to function properly, bypass orifice 48 must constitute a clear passageway for the water, otherwise pressure chamber 22 will be prevented from refilling and ultimately diaphragm assembly 24 will not be maintained in the closed position upon valve seat 26.

However, water supplied to flush valve 10 via inlet 12 inevitably contains particulate, including sediment and dissolved metals in the form of solid particles. This particulate can range in size from approximately 0.075 mm to 1.25 mm and greater. Yet, bypass orifice 48 is a very small opening, ordinarily sized to have a diameter between 0.254 mm and 0.762 mm. Particulate sized smaller than bypass orifice 48 (e.g., particulate with a diameter smaller than 0.254 mm) will pass through bypass orifice 48 during flush operation and need not be accounted for in the design of flush valve filter 11. But, particulate larger than or the same size as bypass orifice 48 (e.g., particulate with a diameter of 0.254 mm or larger) will not pass through bypass orifice 48 during flush operation, and therefore is detrimental to flush valve 10 and must be accounted for in the design of flush valve filter 11. Without proper filtering of the water supplied to flush valve 10 bypass orifice 48 will clog and flush valve 10 will not function.

To ensure bypass orifice 48 is kept free and clear of any particulate large enough to clog bypass orifice 48, and thus flush valve 10 works properly, flush valve filter 11 is used.

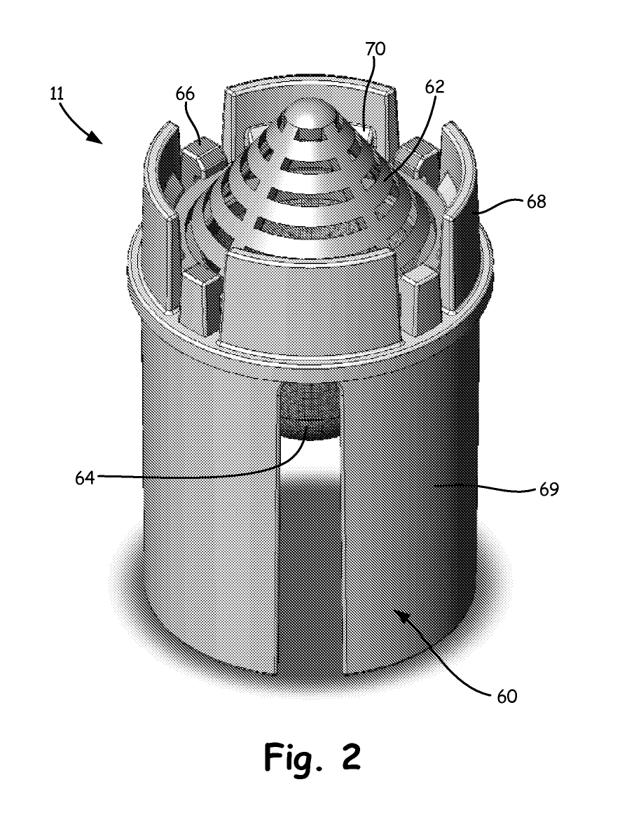

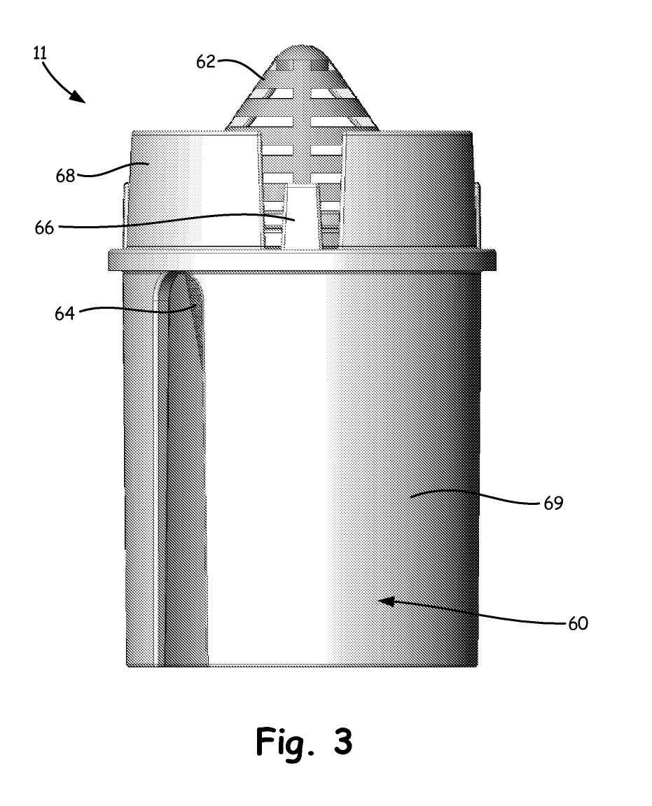

FIGS. 2 and 3 show an embodiment of flush valve filter 11. FIG. 2 illustrates a perspective view of the embodiment of flush valve filter 11, while FIG. 3 illustrates a side elevational view of the embodiment of flush valve filter 11. Flush valve filter 11 includes support structure 60, initial screen 62, screen basket 64, axially extending locking fingers 66 located between axially extending upper aprons 68, axially extending lower aprons 69, and locking lips 70 integral to each upper apron 68. Integral to support structure 60 in the illustrated embodiment are locking fingers 66, upper aprons 68 (and thus locking lips 70), and lower aprons 69. Initial screen 62 sits on top of, and axially extends upstream and out from support structure 60. Initial screen 62 is secured to support structure 60 by locking fingers 66 and locking lips 70. Initial screen 62 in turn secures screen basket 64 to support structure 60, such that screen basket 64 extends axially downstream from an interface with initial screen 62. Upper aprons 68 extend axially upstream, while lower aprons 69 extend axially downstream when flush valve filter 11 is positioned in flush valve 10 (as shown in FIG. 1).

Water supplied from fluid inlet line 12 passes through conduit 14, where flush valve filter 11 is positioned (shown in FIG. 1). The water supply first passes through initial screen 62, which acts as an initial filtering stage for the largest particles in the water supply. Next, after passing through initial screen 62, the water supply continues downstream and passes through screen basket 64. Initial screen 62 serves as a secondary filter medium, and screen basket 64 serves as a primary filter medium. Screen basket 64 has sieve openings sized at 0.250 millimeter (i.e., No. 60 mesh) or smaller. This sieve sizing corresponds to typical bypass orifice 48 diameters, which range from 0.254 to 0.762 millimeter. As a result, the only particles in the water supply that can possibly pass through screen basket 64, and thus flush valve filter 11, are those particles which are too small to clog bypass orifice 48. Consequently, once the water supply exits screen basket 64 the water supply is free of any particles which could detrimentally affect the flush operation. Moreover, the sieve openings in screen basket 64 are not so small such that water supply particles which would not affect bypass orifice 48 are retained, and therefore, achieves a balance between allowing for effective flush operation and low maintenance costs. After passing through screen basket 64, the filtered water supply flows out from flush valve filter 11 and into flush valve 10 where the filtered water supply is used to effectively accomplish the flush operation.

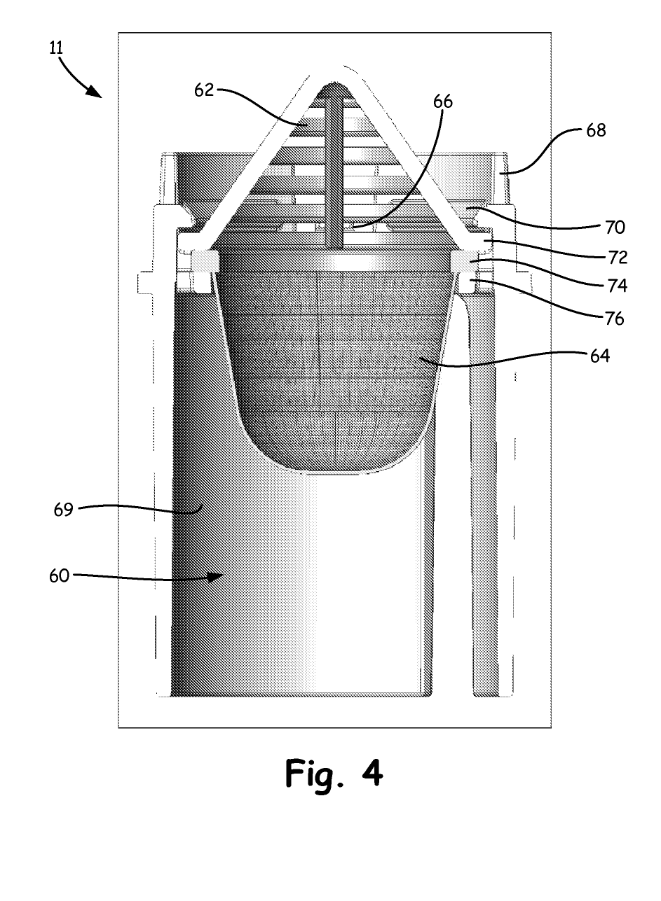

FIG. 4 shows a cross-sectional view of the embodiment of flush valve filter 11 of FIG. 2. Included in FIG. 4, in addition to that shown and described previously, are base 72 of initial screen 62, radially extruded top circumferential perimeter 74 of screen basket 64, and radially extruded circumferential edge 76 of support structure 60.

As shown in FIG. 4, initial screen 62, conical in shape in the illustrated embodiment, is secured in place at base 72 by locking fingers 66 (one shown in sectional view of FIG. 4) and locking lips 70—where locking fingers 66 are not located, locking lips 70 are used to further secure initial screen 62 in place relative to support structure 60. Screen basket 64 hangs inside of support structure 60, supported in a downstream direction by perimeter 74 biased on edge 76 of support structure 60. Screen basket 64 is secured in an upstream direction by base 72 of initial screen 62. In other embodiments of flush valve filter 11 where no initial screen 62 is used, screen basket 64 can be secured to support structure 60 in the upstream direction by one or more locking fingers 66 and/or locking lips 70, with the one or more locking fingers 66 and/or locking lips 70 located appropriately to secure screen basket 64. Thus, screen basket 64 is mated or trapped by an interference fit between edge 76 and base 72 or locking fingers 66 and/or locking lip 70. As shown, flush valve filter 11 secures both initial screen 62 and screen basket 64 in place in an efficient manner that utilizes the stacked configuration of initial screen 62 on top of screen basket 64 to secure both components in place, with locking fingers 66 and locking lips 70 only needing to come in to contact with initial screen 62. As a result, this configuration of flush valve filter 11 provides for quick and easy removal of one or both of initial screen 62 and screen basket 64 for maintenance, while at the same time ensuring both initial screen 62 and screen basket 64 do not become dislodged during operation. Thus, the described configuration allows for both removal and replacement of only initial screen 62 and/or screen basket 64 without disturbing support structure 60 as well as removal and replacement of flush valve filter 11 as a whole. Maintenance and repair of flush valve filter 11 is also made simple due to the easy access provided to flush valve filter 11 as a result of flush valve filter 11 being located in conduit 14, as described for FIG. 1.

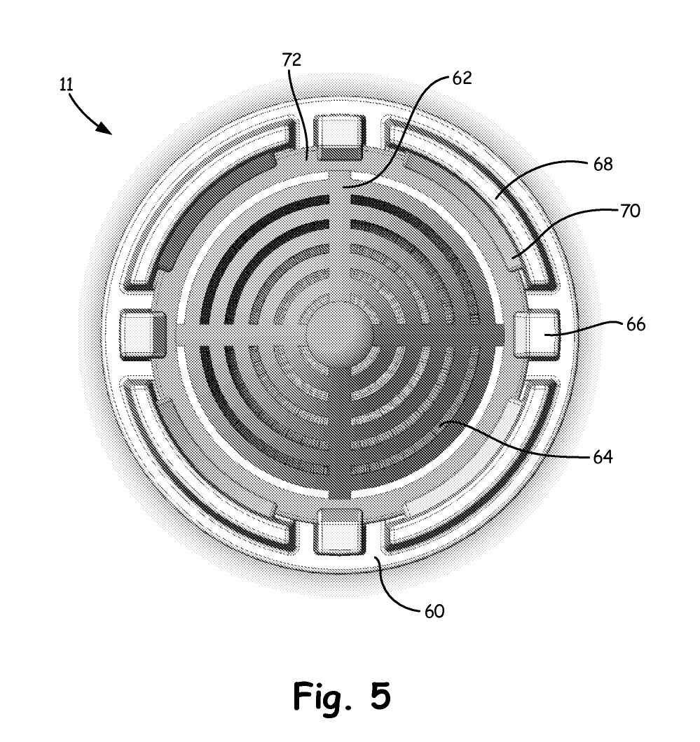

FIG. 5 shows a top plan view of the embodiment of flush valve filter 11 of FIG. 2. As described for FIG. 4, initial screen 62 is secured in place at base 72 of initial screen 62 by locking fingers 66 and locking lips 70. Initial screen 62 can be secured in place as shown in FIG. 5 by sliding initial screen 62 into support structure 60. Where initial screen 62, locking fingers 66, and locking lips 70 are each made of a compliant material (e.g., polymer), initial screen 62 can be pushed into position such that upon initial contact with locking fingers 66 and locking lips 70, initial screen 62, locking fingers 66, and locking lips 70 each deflect due to the pushing force such that initial screen 62 is pushed beyond an interface with locking fingers 66 and locking lips 70 such that initial screen 62 is locked into position. Base 72 sits on top of perimeter 74 of screen basket 64 such that when initial screen 62 is secured in place, screen basket 64 is also secured in place. This described arrangement, and use of a compliant material, also allows for initial screen 62, as well as screen basket 64, to be unsecured and removed from flush valve filter 11 without removing support structure 60 simply by pushing screen basket 64 in an upstream direction such that initial screen 62, locking fingers 66, and locking lips 70 all again deflect and release initial screen 62 and thus screen basket 64.

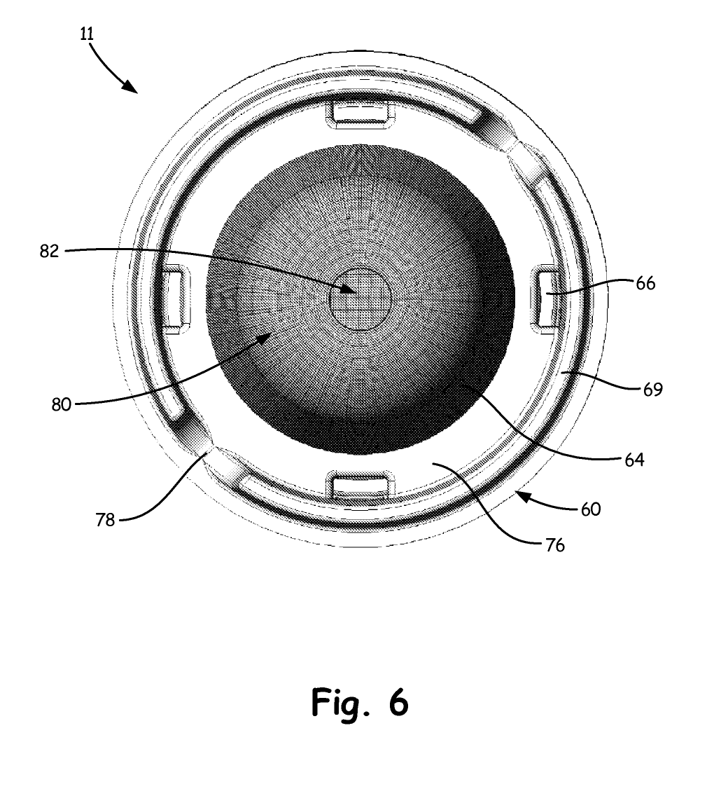

FIG. 6 shows a bottom plan view of the embodiment of flush valve filter 11 of FIG. 2. Screen basket 64 is supported in a downstream direction by perimeter 74 (shown in FIG. 4) biased on edge 76 of support structure 60. From this view, the shape of screen basket 64 in this embodiment can be seen. A portion of the base of screen basket 64 is concave at location 80, relative to the bottom plan view (i.e. convex relative to a top plan view). The concave shape of the base of screen basket 64 at location 80 forms a flat portion 82, which is extruded upstream into screen basket 64. This shape of screen basket 64 allows for particles filtered out of the water supply to accumulate in a trough region formed as a result of the concavity of screen basket 64. However, although particles accumulate in the trough region, the water supply is still able to filter through flat portion 82, which is unaffected by the accumulation of particles because flat portion 82 protrudes upstream from the trough region. Consequently, this shape of screen basket 64 requires less maintenance because screen basket 64 does not need to be cleaned of particles blocking screen basket 64 sieves as frequent as a screen basket with no concavity.

Support structure 60 in the illustrated embodiment contains two cut-outs 78 in a direction extending axially downstream, which define two axially extending lower aprons 69. The cut-outs 78 allow support structure 60 to be compressed, reducing support structure 60 diameter from one lower apron 69 to the other lower apron 69 at a downstream end of support structure 60. Support structure 60 can be made of a compliant material, such as a polymer, that allows support structure 60 to be compressed and is preferably noncorrosive, as any corroded material that comes off of support structure 60 may not be prevented from ultimately reaching bypass orifice 48. Support structure 60 can be compressed when placing flush valve filter 11 inside of conduit 14. Once flush valve filter 11 is inserted inside of conduit 14, support structure 60 then expands (i.e. rebounds) to a diameter of conduit 14, such that support structure 60 (and therefore flush valve filter 11) is held tightly within conduit 14. Thus, cut-outs 78 of support structure 60 allow flush valve filter 11 to be tightly fit into position in conduit 14 such that the tight fit prevents rotation of flush valve filter 11 inside of conduit 14 during operation.

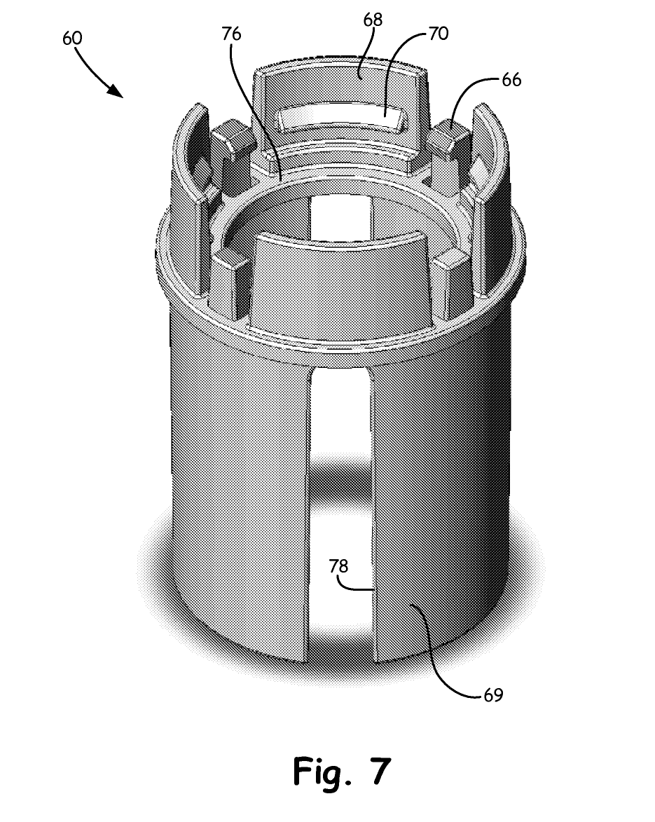

FIG. 7 shows a perspective view of support structure 60 of flush valve filter 11 of FIG. 2. Here, lower aprons 69 and cut-outs 78 can again be seen, along with radially extruded circumferential edge 76 of support structure 60 and locking fingers 66 located between axially extending upper aprons 68 containing locking lips 70.

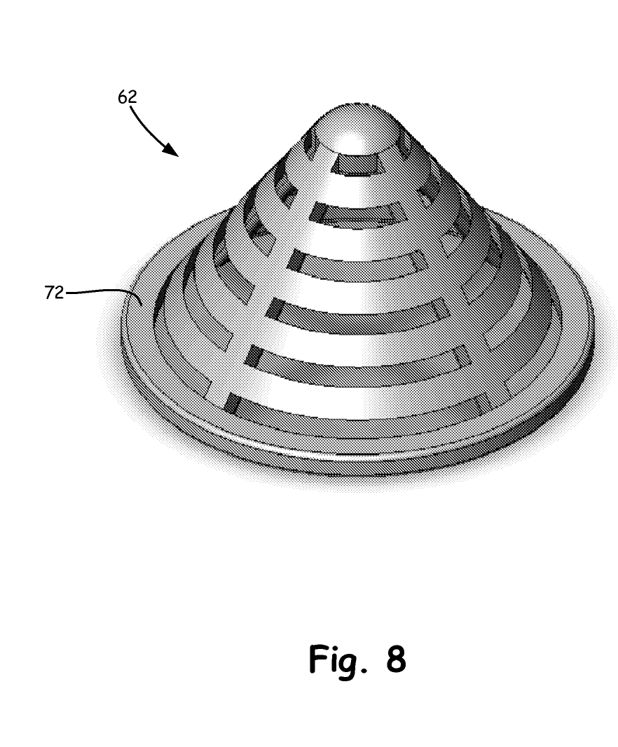

Referring now to FIG. 8, a perspective view of the embodiment of initial screen 62 of flush valve filter 11 of FIG. 2 is shown. In the illustrated embodiment, initial screen 62 is conical in shape and secured in place at base 72. Initial screen 62 can be composed of various corrosion-resistant materials, including metals and polymers (i.e. plastics). Suitable polymer material for initial screen 62 includes, for example, polypropylene (PP), polyethylene (PE), polyvinyl chloride (PVC), polytetrafluoroethylene (PTFE), nylon, and any other polymer-type material suited for extended submersion in water. Suitable metal material for initial screen 62 includes, for example, steel, stainless steel, brass, alloys of such materials, and any other metal material suited for extended submersion in water. However, material used for initial screen 62 does not need to be resistant to corrosion, as any corroded particles of initial screen 62 will substantially be prevented from detrimentally affecting the flush operation by screen basket 64. Thus, the setup of flush valve filter 11 can allow for a cost savings on material used for initial screen 62.

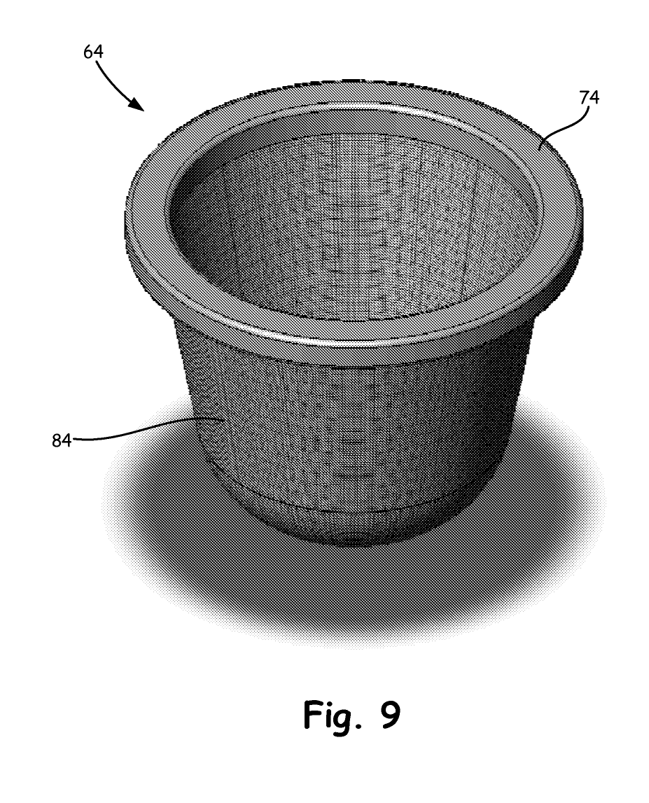

FIG. 9 shows a perspective view of screen basket 64 of flush valve filter 11 of FIG. 2. Screen basket 64 is cup-shaped and contains sieve openings (shown generally at 84) of 0.250 millimeters or smaller, as discussed for FIG. 2. Cup-shaped can mean, for example, an oval or circular shaped perimeter defining the sides with a base on a top or bottom extending an entire area inside the perimeter such that a top or bottom without the base is left open. In other embodiments, other three-sided shapes, and even four sided shapes, can be used for screen basket 64. Screen basket 64 must be made of noncorrosive material, as any corroded particles from the exterior of screen basket 64 will not be filtered and if of a sufficient size (i.e. sized the same as or greater than bypass orifice 48) can ultimately affect the flush operation. Furthermore, corrosion of screen basket 64 can alter the specifically designed size of the sieve openings, which in turn can detrimentally affect the flush operation by allowing larger than intended sized water supply particles to ultimately pass to bypass orifice 48. Thus corrosive materials, such as iron, are not desirable for screen basket 64. Suitable metal materials from which screen basket 64 can be made include, for example, stainless steel, brass, alloys of such metals, and other non-corrosive metals. Also suitable for screen basket 64 are various polymer materials including, for example, polypropylene (PP), polyethylene (PE), polyvinyl chloride (PVC), polytetrafluoroethylene (PTFE), nylon, and other non-corrosive polymer materials.

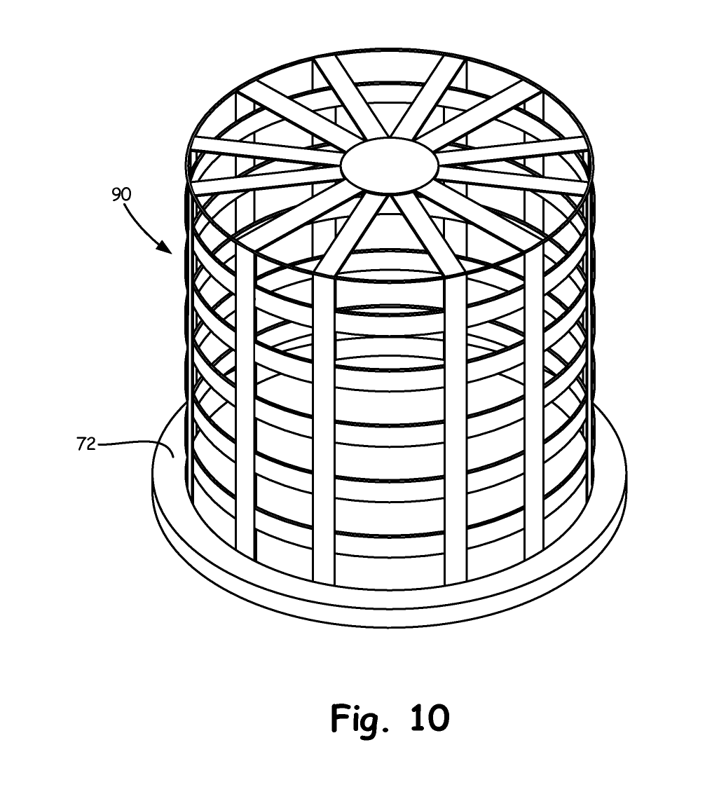

Referring now to FIG. 10, a perspective view of another embodiment of initial screen 90 is shown. Initial screen 90 is similar to initial screen 62 as described previously, except that in the illustrated embodiment initial screen 90 is cylindrical in shape. Initial screen 90 acts as an initial or secondary filtering medium for the largest particles in the water supply and is configured similar to that described for initial screen 62. In other embodiments, initial screen 90 can be various other shapes which act as a secondary filtering medium for the water supply.

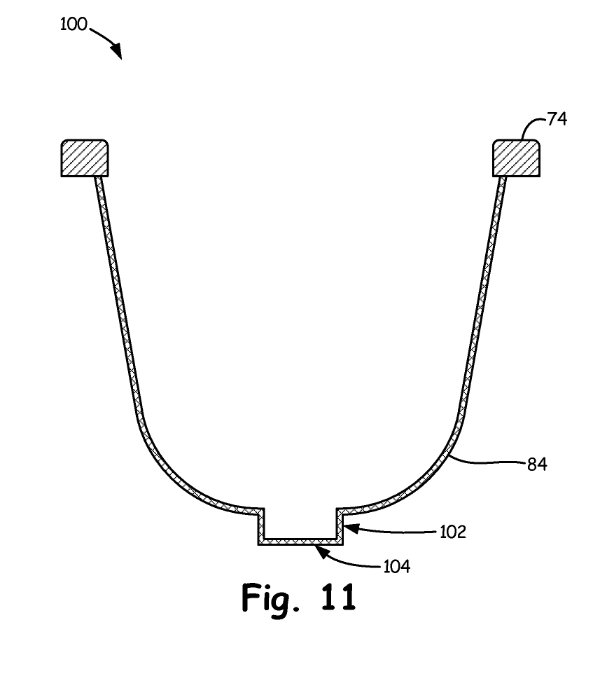

FIG. 11 is a cross-sectional view of another embodiment of screen basket 100. Screen basket 100 is similar to screen basket 64 as described previously, except that in the illustrated embodiment screen basket 100 has a portion of a base of screen basket 100 that is convex (whereas screen basket 64 has a portion of the base of screen basket 64 that is concave). A portion of the base of screen basket 100 is convex at location 102, relative to a bottom plan view (i.e. concave relative to a top plan view) of screen basket 100. The convex shape of the base of screen basket 100 at location 102 forms a flat portion 104, which is extruded downstream, out from screen basket 100. This shape of screen basket 100 allows for particles filtered out of the water supply to accumulate in the convex region at location 102. The convex region of screen basket 100 at location 102 provides additional volume for screen basket 100 to collect particles filtered from the water supply. However, although particles accumulate in the convex region, the water supply is still able to filter through sieve openings 84 in screen basket 100 (sieve openings 84 are sized the same as for screen basket 64). Consequently, this shape of screen basket 100 requires less maintenance because screen basket 100 does not need to be cleaned of particles blocking screen basket 100 sieves 84 as frequent as a screen basket with no convexity.

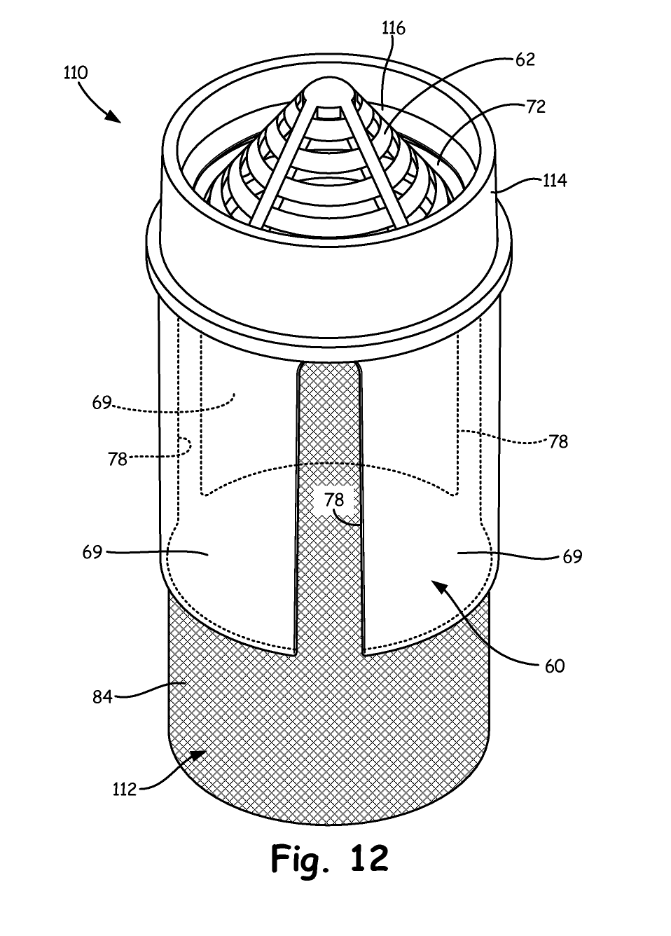

FIG. 12 illustrates a perspective view of another embodiment of flush valve filter 110. Flush valve filter 110 includes, in addition to that shown and described previously, screen basket 112, single circumferentially continuous upper apron 114, and single circumferentially continuous locking lip 116. Flush valve filter 110 is similar to flush valve filter 11, except as described below.

Screen basket 112 is located and supported similar to that described for screen basket 64 and has sieve openings 84 sized at 0.250 millimeter (i.e., No. 60 mesh) or smaller. However, screen basket 112 extends axially beyond a downstream end of each lower apron 69 (i.e. screen basket 112 has a greater axial length than each lower apron 69), resulting in screen basket 112 having a greater volume, relative to screen basket 64. The greater volume of screen basket 112 reduces maintenance costs associated with flush valve filter 110, as more particles from the water supply can be collected in screen basket 112 while still allowing water to filter through sieve openings 84 and ultimately pass to bypass orifice 48 (shown in FIG. 1). Additionally, screen basket 112 has a flat base where particles from the water supply begin to collect. In other embodiments, screen basket 112 can have a concave or convex base portion.

Integral to support structure 60 is single circumferentially continuous upper apron 114, and single circumferentially continuous locking lip 116. Single upper apron 114 includes single locking lip 116. The use of single upper apron 114, and thus single locking lip 116, allows locking fingers 66 (shown, e.g., in FIG. 2) to be eliminated, and as a result flush valve filter 110 can be easier to manufacture while still adequately securing initial screen 62 and screen basket 112 in place.

Flush valve filter 110 includes, as part of support structure 60, three lower aprons 69 defining three cut-outs 78. In other embodiments of flush valve filter 110, more than three lower aprons 69 can be included. The use of three (or more) lower aprons 69 and cut-outs 78 allows support structure 60 to be further compressed, relative to support structure 60 with two lower aprons 69 and two cut-outs 78, such that support structure 60 can be more tightly fit into position in conduit 14 (shown in FIG. 1) or be fit into applications which utilize smaller conduits. The tight fit prevents rotation of flush valve filter 110 inside of conduit 14 during operation. The use of three or more lower aprons 69 can be particularly beneficial in applications, in addition to those that utilize smaller conduits, where the water supply passing through flush valve filter 110 has high velocities.

Although, flush valve filter 110 is illustrated to include initial screen 62, in other embodiments flush valve filter 110 can instead include cylindrical initial screen 90 or any other shape of initial screen.

Any relative terms or terms of degree used herein, such as “generally”, “substantially”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, temporary alignment or shape variations induced by operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A flush valve filter assembly comprising:
a support structure configured to be placed in a conduit between a flush valve and a fluid inlet line, wherein the support structure includes at least one locking finger extending in a first axial direction and at least two axially extending upper aprons extending in the first axial direction with a locking lip on each upper apron, and wherein the at least one locking finger is located between the at least two upper aprons; and
a primary filter medium having sieve openings secured to the support structure by the at least one locking finger and locking lip such that at least some particulate in a fluid passing through the flush valve filter is retained by the primary filter medium.

2. The flush valve filter assembly of claim 1, wherein the support structure further comprises at least two axially extending lower aprons extending in a second axial direction opposite the first axial direction.

3. The flush valve filter assembly of claim 1, wherein the primary filter medium is composed of metal mesh.

4. The flush valve filter assembly of claim 1, wherein the primary filter medium is composed of polymer material mesh.

5. The flush valve filter assembly of claim 1, wherein the primary filter medium is cup-shaped with at least a portion of the primary filter medium base concave.

6. The flush valve filter assembly of claim 1, wherein the primary filter medium is cup-shaped with at least a portion of the primary filter medium base convex.

7. The flush valve filter assembly of claim 2, wherein the primary filter medium extends in the second axial direction and is of a length greater than a length of at least one of the axially extending lower aprons.

8. The flush valve filter assembly of claim 1, wherein the primary filter medium has sieve openings sized at 0.25 millimeter or smaller.

9. The flush valve filter assembly of claim 1, further comprising:
a secondary filter medium wherein a base of the secondary filter medium is located on top of the primary filter medium such that the secondary filter medium extends from the base in the first axial direction in the conduit.

10. The flush valve filter assembly of claim 9, wherein the secondary filter medium is composed of polymer material.

11. The flush valve filter assembly of claim 9, wherein the secondary filter medium is composed of metal.

12. The flush valve assembly of claim 9, wherein the secondary filter medium is conical in shape.

13. The flush valve assembly of claim 9, wherein the secondary filter medium is cylindrical in shape.

14. The flush valve assembly of claim 9, wherein the support structure further comprises at least two axially extending lower aprons extending in a second axial direction opposite the first axial direction.

15. The flush valve assembly of claim 14, wherein the primary filter medium extends in the second axial direction and is of a length greater than a length of at least one of the axially extending lower aprons.

16. A flush valve filter assembly comprising:
a support structure configured to be placed in a conduit between a flush valve and a fluid inlet line having a circumferentially continuous axially extending upper apron with a locking lip located on at least a portion of the upper apron; and
a screen basket secured to the support structure by the locking lip.

17. The flush valve filter assembly of claim 16, wherein the support structure has at least three separate axially extending lower aprons.

18. A flush valve filter comprising:
a support structure configured to be placed in a conduit between a flush valve and a fluid inlet line wherein the support structure comprises at least two axially extending lower aprons of a first length; and
a screen basket secured to the support structure such that at least some particulate in a fluid passing through the flush valve filter is retained by the screen basket, wherein the screen basket is of a second length that is greater than the first length.

19. The flush valve filter assembly of claim 18, wherein the support structure further comprises at least one locking finger extending axially from the support structure to secure the screen basket to the support structure.

20. The flush valve filter assembly of claim 18, wherein the support structure contains at least two axially extending upper aprons each with a locking lip for securing the screen basket to the support structure.
